(19) United States
(12) Patent Application Publication
(10) Pub. No.: US 2023/0307674 A1
(43) Pub. Date: Sep. 28, 2023

(54) FUEL CELL SYSTEM

(71) Applicant: HONDA MOTOR CO., LTD., Tokyo (JP)

(72) Inventors: Tomoyuki INOUE, WAKO-SHI (JP); Takuya TAMURA, WAKO-SHI (JP); Keigo OSADA, WAKO-SHI (JP)

(21) Appl. No.: 18/113,400

(22) Filed: Feb. 23, 2023

(30) Foreign Application Priority Data
Mar. 23, 2022 (JP) 2022-046185

(51) Int. Cl. H01M 8/04302; H01M 8/04858; H01M 8/04701

(52) U.S. Cl. CPC H01M 8/04302; H01M 8/04953; H01M 8/04731

(57) ABSTRACT

If coolant temperature remains higher than a temperature threshold for a first predetermined time period (step S5: YES) and thereafter an electrical resistance value remains higher than a resistance threshold for a second predetermined time period (step S7: YES), a control device determines that a fuel cell stack is in a dry condition and performs the process of limiting a power generation amount of the fuel cell stack (step S8).

### CROSS-REFERENCE TO RELATED APPLICATIONS

This application is based upon and claims the benefit of priority from Japanese Patent Application No. 2022-046185 filed on Mar. 23, 2022, the contents of which are incorporated herein by reference.

### BACKGROUND OF THE INVENTION

### Field of the Invention

The present invention relates to a fuel cell system that is capable of appropriately controlling an auxiliary electrical device of a fuel cell stack at the time of start-up operation.

### Description of the Related Art

In recent years, research and development have been conducted on fuel cells that contribute to energy efficiency in order to ensure that more people have access to affordable, reliable, sustainable and modern energy.

For example, JP 2013-235751 A discloses a fuel cell system in which an electric resistance value (referred to as a local resistance value) of a power generation cell having the highest operating temperature is measured, and a target generated current is set so as to avoid a range of generated current (a limit range) in which the measured electric resistance value exceeds a predetermined limit resistance value.

It is described that by setting the target generated current in this manner, deterioration of the fuel cell caused by drying of the membrane electrode assembly can be suppressed.

### SUMMARY OF THE INVENTION

With respect to the durability of a fuel cell stack, the humidity at an oxygen-containing gas inlet part of the fuel cell stack and a wet state of an electrolyte membrane are important. The electrolyte membrane deteriorates when a dry condition continues.

Water generated by power generation inside the fuel cell stack is proportional to generated current. When the water generated by power generation decreases, the amount of water tends to be insufficient. Further, when the temperature of the fuel cell stack is high, its humidity decreases.

For these reasons, the electrolyte membrane of the fuel cell stack is easily dried under conditions where the fuel cell stack has a low load to an intermediate load, and where the fuel cell stack is likely to have a high temperature, for example, at the time of deceleration after uphill traveling or at the time of uphill traveling at a low vehicle speed with a fuel cell vehicle.

As a method for detecting drying of the electrolyte membrane, there is a membrane resistance measuring method. When a film resistance is measured and the resistance value is high, it can be determined that the film is dry.

In the fuel cell system disclosed in JP 2013-235751 A, a map indicating a relationship between the local resistance value and a measured resistance value of the fuel cell stack ((a generated voltage value of the fuel cell stack)/(a generated current value of the fuel cell stack)) is stored in advance.

Then, the local resistance value is calculated by referring to the map based on the actually measured resistance value, and the target generated current is set if the calculated local resistance value exceeds the limit resistance value.

However, in the case where the target generated current is set based only on the measured resistance value of the electric resistance value of the power generation cell, when a detection error of a measurement unit, an output of a numerical value other than a normal value, or the like occurs, the following inconvenience occurs.

For example, when a positive error (an error by which the resistance increases) occurs in the measured resistance value during traveling of the fuel cell vehicle in a high load state of the fuel cell stack and the target generated current is set such that generated current will be limited, drivability deteriorates due to a decrease in the generated current, and there is a high possibility that a sense of unease or discomfort may be imparted to the user. That is, there is a problem in that the process of limiting power generation amount occurs more than necessary.

An object of the present invention is to solve the above-described problems.

A fuel cell system according to an aspect of the present invention includes a fuel cell stack configured to generate electric power by an electrochemical reaction between a fuel gas and an oxygen-containing gas, a temperature acquisition unit configured to acquire a temperature of the fuel cell stack, a resistance acquisition unit configured to acquire an electrical resistance value of the fuel cell stack, a control device configured to control a power generation amount of the fuel cell stack, wherein the control device limits a power generation amount if the temperature acquired by the temperature acquisition unit is higher than a temperature threshold and the electrical resistance value is higher than a resistance threshold.

According to the present invention, the two conditions of the electrical resistance value of the fuel cell stack and the temperature of the fuel cell stack are used as the conditions for starting the limiting process of the power generation amount. Thus, the limiting process of the power generation amount is not started more than necessary, which is excellent for user convenience.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic configuration diagram of a fuel cell vehicle incorporating a fuel cell system according to an embodiment of the present invention;

FIG. 2 is a flowchart for explaining the operation of the fuel cell vehicle during traveling or during stopping and idling;

FIG. 3 is a temperature threshold map; and

FIG. 4 is an explanatory diagram of an example of a current limiting process with reference to a temperature threshold map.

### DETAILED DESCRIPTION OF THE INVENTION

### Embodiment

### [Configuration]

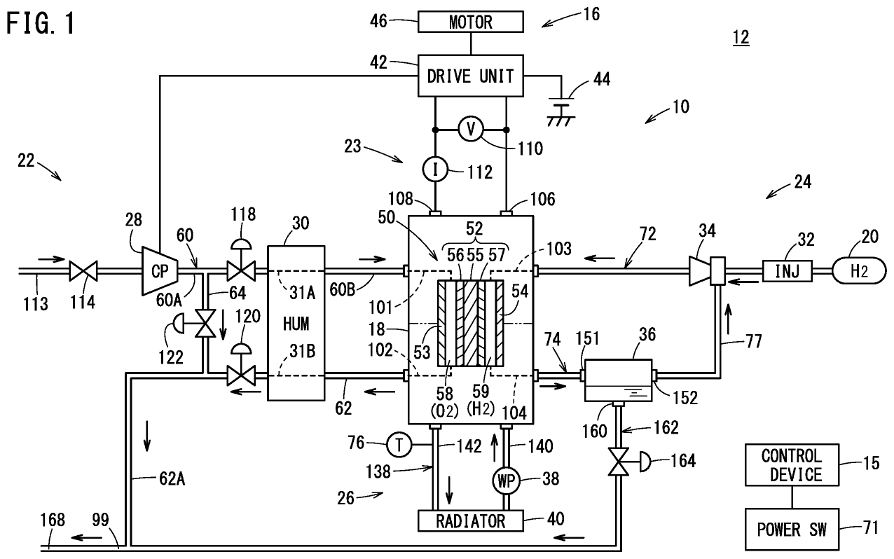

FIG. 1 is a schematic configuration diagram of a fuel cell vehicle 12 incorporating a fuel cell system 10 according to an embodiment of the present invention.

The fuel cell system 10 can be incorporated into other mobile bodies such as ships, aircrafts, and robots other than the fuel cell vehicle 12.

The fuel cell vehicle 12 includes a control device 15 for controlling the entire fuel cell vehicle 12, the fuel cell system 10, and an output unit 16 electrically connected to the fuel cell system 10.

For example, the control device 15 may be divided into two or more control devices such as a control device for the fuel cell system 10 and a control device for the output unit 16.

The fuel cell system 10 includes a fuel cell stack (also simply referred to as a fuel cell) 18, a hydrogen tank 20, an oxygen-containing gas supply device 22, a fuel gas supply device 24, and a coolant supply device 26.

The oxygen-containing gas supply device 22 includes a compressor (CP) 28 and a humidifier (HUM) 30.

The fuel gas supply device 24 includes an injector (INJ) 32, an ejector 34, and a gas-liquid separator 36. The injector 32 may be replaced with a pressure reducing valve.

The coolant supply device 26 includes a coolant pump (WP) 38 and a radiator 40. The radiator 40 cools the circulating coolant by a traveling wind or a radiator fan (not shown) and performs heat exchange.

The output unit 16 includes a drive unit 42, a high voltage electrical power storage device (battery) 44, and a motor (electric motor) 46. Loads of the drive unit 42 include vehicle auxiliary devices such as the compressor 28, the coolant pump 38, and an air conditioner, in addition to the motor 46 which is a vehicle main device. The fuel cell vehicle 12 travels by the drive force generated by the motor 46.

A plurality of power generation cells 50 are stacked in the fuel cell stack 18. Each of the power generation cells 50 includes a membrane electrode assembly 52, and a pair of separators 53 and 54 that sandwich the membrane electrode assembly 52.

The membrane electrode assembly 52 includes, for example, a solid polymer electrolyte membrane 55 which is a thin film of perfluorosulfonic acid containing water, and a cathode 56 and an anode 57 which sandwich the solid polymer electrolyte membrane 55.

Each of the cathode 56 and the anode 57 has a gas diffusion layer (not shown) made from carbon paper or the like. An electrode catalyst layer (not shown) in which platinum alloy is supported on porous carbon particles is coated uniformly on the surface of the gas diffusion layer. The electrode catalyst layer is formed on both surfaces of the solid polymer electrolyte membrane 55, respectively.

On a surface of one separator 53 facing the membrane electrode assembly 52, a cathode flow field (oxygen-containing gas flow field) 58 in communication with an oxygen-containing gas inlet connection port 101 and an oxygen-containing gas outlet connection port 102 is formed.

On a surface of another separator 54 that faces the membrane electrode assembly 52, an anode flow field (a fuel gas flow field) 59 in communication with a fuel gas inlet connection port 103 and a fuel gas outlet connection port 104 is formed.

At the anode 57, when the fuel gas (hydrogen) is supplied, hydrogen ions are generated from hydrogen molecules by electrode reactions on the catalyst, and the hydrogen ions permeate through the solid polymer electrolyte membrane 55 and move to the cathode 56, while electrons are released from the hydrogen molecules.

The electrons released from the hydrogen molecules move from a negative electrode terminal 106 to the cathode 56 via a positive electrode terminal 108 through loads such as the drive unit 42 and the motor 46.

At the cathode 56, the hydrogen ions and the electrons react with oxygen contained in the supplied oxygen-containing gas by the action of the catalyst to generate water.

A voltage sensor 110 that detects generated voltage Vfc, is provided between wires that connect the positive electrode terminal 108 and the negative electrode terminal 106 to the drive unit 42. Further, a current sensor 112 that detects generated current Ifc is provided in the wire that connects the positive electrode terminal 108 and the drive unit 42. A power generation amount (generated electric power) is acquired by the voltage sensor 110 and the current sensor 112.

Although the unit of power generation amount (generated electric power) is [W], since the magnitude of the generated electric power of the fuel cell stack 18 is increased or decreased by the control device 15 controlling the generated current Ifc [A], in the present specification, the power generation amount is detected (measured) by the generated current Ifc for convenience of understanding.

The voltage sensor 110 and the current sensor 112 also function as a resistance acquisition unit 23 that acquires an electrical resistance value R (R=Vfc/Ifc) of the fuel cell stack 18. The electrical resistance value R [Ω] is low when the solid polymer electrolyte membrane 55 is in a wet condition, and is high when the solid polymer electrolyte membrane 55 is in a dry condition. The solid polymer electrolyte membrane 55 deteriorates when a dry condition continues.

An AC impedance meter may be provided between the positive electrode terminal 108 and the negative electrode terminal 106 to measure an AC impedance [Ω] having a high correlation with the electrical resistance value R, instead of the electrical resistance value R.

The compressor 28 is configured by a mechanical supercharger or the like driven by a compressor motor (not shown) to which the power of the electrical power storage device 44 is supplied through the drive unit 42. The compressor 28 has a function of suctioning and pressurizing outside air (atmosphere, air) from an outside air intake port 113 and supplying the outside air to the fuel cell stack 18 through the humidifier 30.

The humidifier 30 has a flow path 31A and a flow path 31B. Air (oxygen-containing gas) that is compressed by the compressor 28, heated to a high temperature, and dried, flows through the flow path 31A. A wet oxygen-containing off-gas as the exhaust gas discharged from the oxygen-containing gas outlet connection port 102 of the fuel cell stack 18, flows through the flow path 31B.

The humidifier 30 has a function of humidifying the oxygen-containing gas supplied from the compressor 28. That is, the humidifier 30 makes moisture contained in the oxygen-containing off-gas move from the flow path 31B to the supply gas (oxygen-containing gas) flowing in the flow path 31A through an inside porous membrane to humidify the supply gas, and supplies the humidified oxygen-containing gas to the fuel cell stack 18.

A shut-off valve 114, the compressor 28, a supply-side stop valve 118, and the humidifier 30 are provided, in this order, in an oxygen-containing gas supply flow path 60 (including the oxygen-containing gas supply paths 60A and 60B) from the outside air intake port 113 to the oxygen-containing gas inlet connection port 101. Note that the flow paths such as the oxygen-containing gas supply flow path 60 drawn by double lines are formed by pipes (the same applies hereinafter). The shut-off valve 114 is opened to allow or closed to shut off intake of the air into the oxygen-containing gas supply flow path 60. The supply-side stop valve 118 opens and closes the oxygen-containing gas supply flow path 60A.

An oxygen-containing off-gas flow path 62 connected to the oxygen-containing gas outlet connection port 102 is provided with the humidifier 30 and a discharge-side stop valve 120 that also functions as a back pressure valve in this order, from the oxygen-containing gas outlet connection port 102.

A bypass flow path 64 is provided between a suction port of the supply-side stop valve 118 and an outlet port of the discharge-side stop valve 120 to communicate the oxygen-containing gas supply flow path 60 with the oxygen-containing off-gas flow path 62. The bypass flow path 64 is provided with a bypass valve 122 that opens and closes the bypass flow path 64. The bypass valve 122 regulates the flow rate of the oxygen-containing gas bypassing the fuel cell stack 18. A merging path of the bypass flow path 64 and the oxygen-containing off-gas flow path 62 communicates with a discharge flow path 62A.

The hydrogen tank 20 is a container including a solenoid shut-off valve, and compresses highly pure hydrogen under high pressure, and stores the compressed hydrogen.

The fuel gas discharged from the hydrogen tank 20 is supplied to an inlet of the anode flow field 59 of the fuel cell stack 18 via the fuel gas inlet connection port 103 through the injector 32 and the ejector 34 provided in a fuel gas supply flow path 72.

The outlet port of the anode flow field 59 communicates with an inlet port 151 of the gas-liquid separator 36 through the fuel gas outlet connection port 104 and a fuel off-gas flow path 74, and the fuel off-gas which is a hydrogen-containing gas is supplied from the anode flow field 59 to the gas-liquid separator 36.

The gas-liquid separator 36 separates the fuel off-gas into a gas component and a liquid component (liquid water). The gas component of the fuel off-gas (fuel exhaust gas) is discharged from a gas exhaust port 152 of the gas-liquid separator 36 and supplied to the suction port of the ejector 34 through a circulation flow path 77.

The liquid component of the fuel exhaust gas flows from a liquid discharge port 160 of the gas-liquid separator 36 through a drain flow path 162 provided with a drain valve 164, is mixed with the exhaust gas discharged from the discharge flow path 62A, and is discharged to outside air through a discharge flow path 99 and an exhaust gas exhaust port 168.

Actually, a part of the fuel off-gas (hydrogen-containing gas) is discharged to the drain flow path 162 together with the liquid component. In order to dilute hydrogen gas in the fuel off-gas and discharge it to outside, part of oxygen-containing gas discharged from the compressor 28 is supplied to the discharge flow path 62A through the bypass flow path 64. The discharge flow path 62A communicates with the drain flow path 162, and merges into and communicates with the discharge flow path 99.

In the discharge flow path 99, the fuel gas in the mixed fluid of the liquid water and the fuel off-gas discharged from the drain flow path 162 is diluted by the oxygen-containing off-gas from the discharge flow path 62A, and is discharged to the outside (atmosphere) of the fuel cell vehicle 12 through the exhaust gas exhaust port 168.

The coolant supply device 26 of the fuel cell system 10 includes a coolant flow path 138 through which a coolant flows. The coolant flow path 138 includes a coolant supply flow path 140 and a coolant discharge flow path 142. The coolant supply flow path 140 supplies the coolant to the fuel cell stack 18, and the coolant discharge flow path 142 discharges the coolant from the fuel cell stack 18. The radiator 40 is connected to the coolant supply flow path 140 and the coolant discharge flow path 142. The radiator 40 cools the coolant.

The coolant pump 38 is provided in the coolant supply flow path 140. The coolant pump 38 circulates the coolant in a coolant circulation circuit. The coolant circulation circuit includes the coolant supply flow path 140, an internal coolant flow field (not shown) of the fuel cell stack 18, the coolant discharge flow path 142, and the radiator 40. A temperature acquisition unit 76, which is a temperature sensor, is provided in the coolant discharge flow path 142. Temperature (coolant outlet temperature) Tw of the coolant detected by the temperature acquisition unit 76 is detected (measured) as the (internal) temperature of the fuel cell stack 18. The above-described components of the fuel cell system 10 are collectively controlled by the control device 15.

The supply-side stop valve 118, the bypass valve 122, the discharge-side stop valve 120, and the drain valve 164, excluding the shut-off valve 114 that is an on-off valve the opening and closing of which is controlled by the control device 15, are flow regulating valves whose opening degrees are controlled by the control device 15. However, they may be solenoid-controlled on-off valves that are operated by duty control.

The control device 15 is configured by an electronic control unit (ECU). The ECU is configured by a computer including one or more processors (CPUs), a memory, an input/output interface, and an electronic circuit. The one or more processors (CPUs) execute a program (computer-executable instructions) (not illustrated) stored in the memory.

The processor (CPU) of the control device 15 performs operation control of the fuel cell vehicle 12 and the fuel cell system 10 by executing calculation in accordance with the program.

A power switch 71 of the fuel cell vehicle 12 is connected to the control device 15 (for starting or continuing (ON), or terminating (OFF) the power generation operation of the fuel cell stack 18 of the fuel cell system 10). In addition, an accelerator opening sensor, a vehicle speed sensor, and an SOC sensor of the electrical power storage device 44, none of which are shown, are connected to the control device 15.

### [Operation]

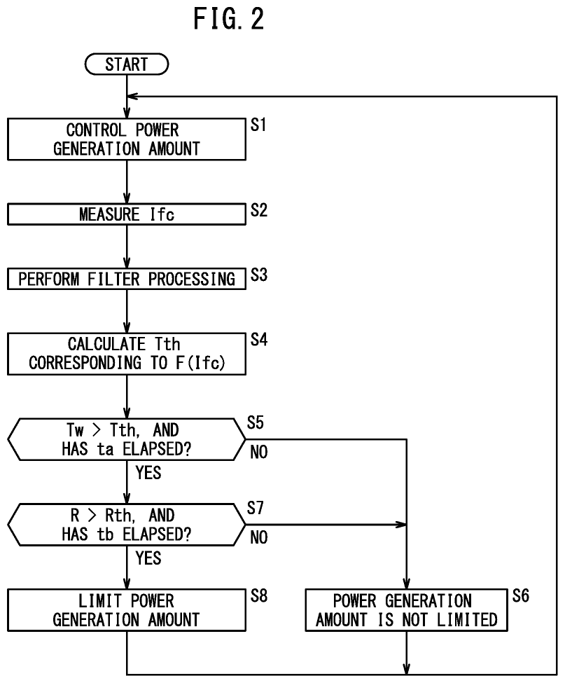

The fuel cell system 10 according to the present embodiment is configured basically as described above. Hereinafter, with reference to the flowchart of FIG. 2, the operation of the fuel cell vehicle 12 during the ON state of the power switch 71 (during travelling or stopping and idling) will be described. The process according to the flowchart of FIG. 2 is repeatedly executed at a predetermined cycle by the control device 15.

In step S1, the control device 15 performs power generation amount control of the fuel cell vehicle 12. In this case, the control device 15 calculates the demanded power for the fuel cell system 10 based on an accelerator opening, a vehicle speed, a road gradient, and the like of the fuel cell vehicle 12. The demanded power is a total value of the demanded generated power for the fuel cell stack 18 and the discharge power of the electrical power storage device 44 as necessary. That is, the demanded power for the fuel cell system 10 of the fuel cell vehicle 12 is covered by the generated electric power of the fuel cell stack 18 and the discharge power of the electrical power storage device 44 when the generated electric power is insufficient.

In this case, the control device 15 controls the oxygen-containing gas supply device 22 including the compressor 28 and the fuel gas supply device 24 including the hydrogen tank 20, and controls the coolant supply device 26 including the coolant pump 38 so that the electric power generated by the fuel cell stack 18 becomes the calculated demanded power.

Arrows in FIG. 1 indicate an example of flow of fluids (oxygen-containing gas, fuel gas, oxygen-containing off-gas, fuel off-gas, liquid water, and coolant) when the power switch 71 is in the ON state.

Next, in step S2, the control device 15 measures (acquires) the generated current Ifc by the current sensor 112 in order to detect the power generation amount, and advances the process to step S3.

In step S3, the control device 15 filters the generated current Ifc. This filter processing is performed to prevent errors in processing due to instantaneous current.

As the filter processing, it is possible to employ a moving average or an arithmetic average of a predetermined number of continuous measurement values up to the current measurement value. The process in the flowchart is performed at a predetermined cycle. The moving average corresponds to a low pass filter processing value, and the arithmetic average corresponds to an average processing value within a predetermined time period. In this embodiment, the moving average is employed. Here, a filter processing value (or a filtered value) of the generated current Ifc is referred to as F(Ifc).

Next, at step S4, the control device 15 calculates a temperature threshold Tth corresponding to the filter processing value F(Ifc) of the generated current Ifc.

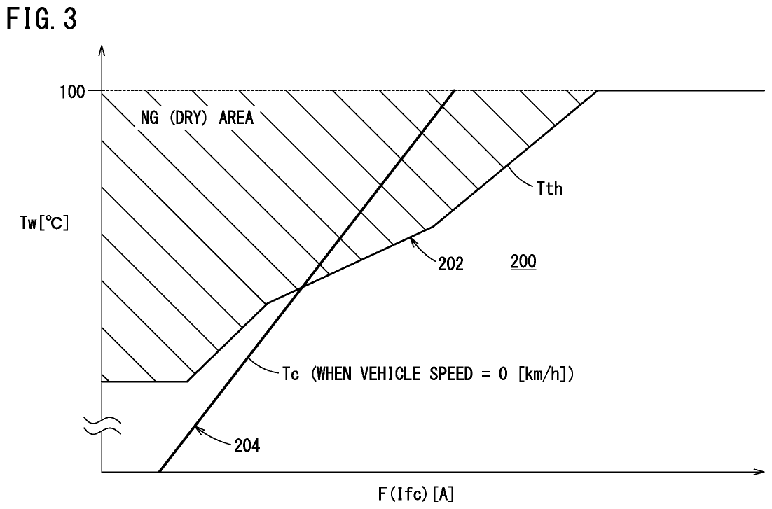

FIG. 3 illustrates a temperature threshold map 200 that is an acquired map of the temperature threshold Tth recorded in advance in the storage unit of the control device 15. The temperature threshold map 200 is actually measured for each fuel cell system 10. The temperature threshold map 200 is a table in which output values are assigned to input values. Here, an input value is the filter processing value F(Ifc), and an output value is the temperature threshold Tth indicating an upper limit temperature of coolant temperature Tw.

The horizontal axis of the temperature threshold map 200 indicates the filter processing value F(Ifc) [A] of the generated current Ifc, the vertical axis indicates the coolant temperature Tw [° C.], and a drying boundary line 202 is a line connecting the temperature thresholds Tth corresponding to the filter processing values F(Ifc) of the generated currents Ifc.

As can be understood from the drying boundary line 202 generally having a positive slope, as the generated current Ifc decreases, the amount of water generated in the cathode flow field 58 decreases, and as the coolant temperature Tw (which is proportional to the temperature of the cathode flow field 58) increases, drying of the cathode flow field 58 of the fuel cell stack 18 is promoted and the humidity decreases, so drying of the fuel cell stack 18 is promoted.

A hatched area where the coolant temperature Tw is higher than the drying boundary line 202 indicates a NG (drying) area where drying is promoted.

The temperature threshold map 200 may be created using a fuel off-gas temperature in the fuel off-gas flow path 74 or an oxygen-containing off-gas temperature in the oxygen-containing off-gas flow path 62, instead of the coolant temperature Tw.

In the fuel cell stack 18, the humidity is controlled such that the temperature of the oxygen-containing gas outlet connection port 102 (the oxygen-containing off-gas flow path 62) is equal to or higher than the saturated water vapor pressure (the amount of saturated water vapor).

In FIG. 3, a straight line characteristic 204 indicated by a thick solid line with a positive slope indicates a characteristic of a convergence temperature Tc [° C.] of the coolant temperature Tw during idling of the fuel cell vehicle 12 (vehicle speed=0 [km/h]).

The generated electric power during idling is supplied to the auxiliary electrical devices such as the compressor 28 and the coolant pump 38, and the surplus power is stored in the electrical power storage device 44. Further, during idling, the coolant is cooled by the radiator 40 in which heat is exchanged by a radiator fan (not shown).

In step S4, the control device 15 calculates the temperature threshold Tth corresponding to the filter processing value F(Ifc) of the generated current Ifc with reference to the temperature threshold map 200, and advances the process to step S5. In the temperature threshold map 200, the temperature threshold Tth indicates an upper limit temperature of the coolant temperature Tw detected by the temperature sensor 76, and thus can also be referred to as an upper limit coolant outlet temperature.

In step S5, the control device 15 acquires the coolant temperature Tw by the temperature acquisition unit 76, and determines whether or not the acquired coolant temperature Tw is higher than the temperature threshold Tth (FIG. 3) and a first predetermined time period ta has elapsed.

That is, in step S5, when the coolant temperature Tw is equal to or lower than the temperature threshold Tth (Tw≤Tth) (step S5: NO), advances the process to step S6.

When the coolant temperature Tw is higher than the temperature threshold Tth, down-counting of the first predetermined time period ta is started (step S5: NO), and the process proceeds to step S6.

In step S6, the control device 15 continues power generation amount unlimited processing in which the power generation amount is not limited. That is, if the coolant temperature Tw is equal to or lower than the temperature threshold Tth (step S5: NO) or if a state where the coolant temperature Tw is higher than the temperature threshold Tth has not continued for the first predetermined time period ta (step S5: NO), the control device 15 determines that the fuel cell stack 18 (solid polymer electrolyte membrane 55) has not reached the dry condition and is still in the wet condition, and returns the process to step S1 without performing the limiting process for the power generation amount.

Repetition process time, in which process is repeated (step S5 (NO, where Tw>Tth)→step S6→steps S1 to S4→step S5 (NO, where Tw>Tth)), exceeds the first predetermined time period ta (step S5: YES), the control device 15 advances the process to step S7. However, when the coolant temperature Tw becomes equal to or lower than the temperature threshold Tth before the first predetermined time period ta elapses, counting of the first predetermined time period ta is reset.

In step S7, the control device 15 acquires, by the resistance acquisition unit 23, an electrical resistance value R (R=Vfc/Ifc) that is a value acquired by dividing the generated voltage Vfc detected by the voltage sensor 110 by the generated current Ifc detected by the current sensor 112.

Further, in step S7, the control device 15 determines whether or not the electrical resistance value R exceeds a predetermined resistance threshold Rth (R>Rth) for determining whether or not the stack is the dry condition, and whether or not a state where the electrical resistance value R exceeds the resistance threshold Rth has continued for a second predetermined time period tb.

If it is determined in step S7 that the electrical resistance value R is equal to or less than the resistance threshold value Rth (R≤Rth, step S7: NO), the control device 15 resets the counting of the first predetermined time period ta, and returns the process to step S1 through step S6 (without limiting power generation amount).

On the other hand, if it is determined in step S7 that the electrical resistance value R is greater than the resistance threshold Rth (R>Rth), the control device 15 starts the down-counting of the second predetermined time period tb (step S7: NO), and returns the process to step S1 through step S6 (without limiting power generation amount).

Repetition process time, in which process is repeated (step S7 (NO)→step S6→steps S1 to S4→step S5 (YES, where the first predetermined time period ta has been counted)→step S7 (NO, where R>Rth)), exceeds the second predetermined time period tb (step S7: YES), the control device 15 advances the process to step S8. However, if the condition of Tw≤Tth (step S5: NO) or R≤Rth (step S7: NO) is satisfied before the end of the counting of the second predetermined time period tb in the repetition process, the counting of the first predetermined time period ta and the second predetermined time period tb is reset, and the process returns to step S1 via step S6.

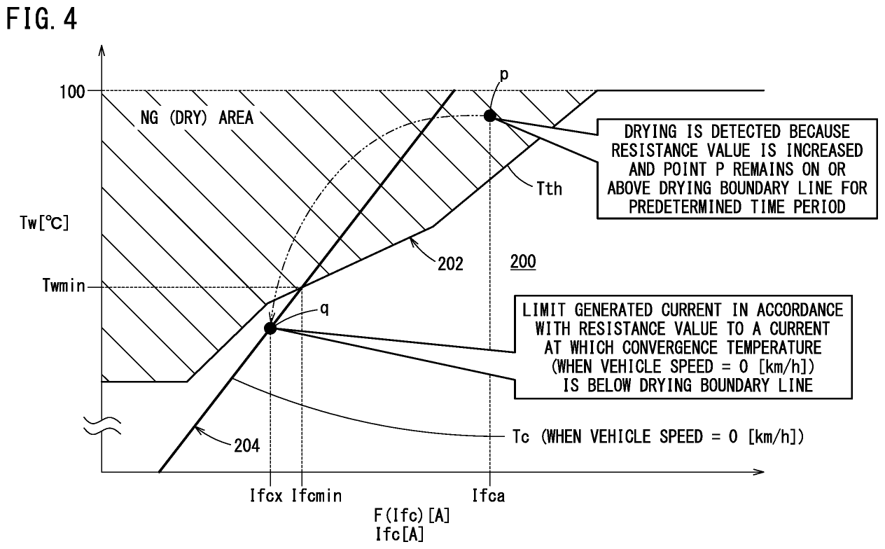

When the evaluation in step S7 is true (step S7: YES), the control device 15 advances the process to step S8. In other words, the control device 15 determines that the fuel cell stack 18 is in the dry condition and advances the process to step S8 if the coolant temperature Tw continues exceeding the temperature threshold Tth for the first predetermined time period ta and thereafter the electrical resistance value R continues exceeding the resistance threshold Rth for the second predetermined time period tb. In step S8, the control device 15 limits the power generation amount of the fuel cell stack 18. An example of the limiting process in step S8 will be described with reference to FIG. 4.

As an example of a case in which the evaluation in step S7 is true (step S7: YES), in FIG. 4, if the elapsed time that the power generation state (the point p) is plotted in the NG (dry) area becomes a predetermined time period (first predetermined time period ta+second predetermined time period tb), the control device 15 determines that the fuel cell stack 18 is in the dry condition, and limits the generated current Ifc so that the stack is in the power generation state at the point q, for example, in step S8.

In this case, in step S8, the control device 15 limits the generated current Ifc (Ifc is Ifca at point p) to a generated current Ifcx as a target current. The generated current Ifcx is below a minimum generated current Ifcmin at which a convergence temperature Tc [° C.] of the coolant temperature Tw during idling (vehicle speed=0 [km/h]) is equal to or lower than a minimum coolant temperature Twmin intersecting the drying boundary line 202. Here, Ifcmin−Ifcx is a margin (margin power generation amount) for avoiding hunting of the process.

In the power generation control in step S1 during the limitation of the power generation amount in step S8, the drive current corresponding to the limited amount (difference in amount) of power generation is supplied from the electrical power storage device 44 to the motor 46 so as not to reduce the drivability of the fuel cell vehicle 12. In this way, as described above, the demanded power for the fuel cell system 10 of the fuel cell vehicle 12 is covered.

In addition, when the evaluation of step S5 becomes false during the repetition control of the process (step S8→steps S1 to S4→step S5 (YES)→step S7 (YES)→step S8), the control device 15 ends the limiting process of the power generation amount.

That is, when the coolant temperature Tw decreases to a temperature lower than the temperature threshold Tth of the drying boundary line 202 (Tw≤Tth, step S5: NO) during the limitation of the power generation amount, the control device 15 cancels the limitation of power generation amount since the stack is out of the NG (dry) area regardless of whether the electrical resistance value R exceeds the resistance threshold Rth.

By cancelling the limitation of the power generation amount, the amount of water generated by power generation in the fuel cell stack 18 increases and the electrical resistance value R decreases. Therefore, the time for limiting the power generation amount can be shortened, and the dry condition of the solid polymer electrolyte membrane 55 can be eliminated (the solid polymer electrolyte membrane 55 can be released from the dry condition) more quickly.

[Invention that can be Obtained from Embodiment]

Hereinafter, inventions that can be obtained from the above-described embodiment will be described below. Although to facilitate understanding, some of the constituent elements are designated by the reference numerals used in the above-described embodiment, the constituent elements are not limited to those elements to which such reference numerals are applied.

(1) The fuel cell system 10 according to the present invention includes the fuel cell stack 18 configured to generate electric power by an electrochemical reaction between a fuel gas and an oxygen-containing gas, the temperature acquisition unit 76 configured to acquire the temperature of the fuel cell stack, the resistance acquisition unit 23 configured to acquire the electrical resistance value R of the fuel cell stack, the control device 15 configured to control a power generation amount of the fuel cell stack, wherein the control device limits a power generation amount if the temperature Tw acquired by the temperature acquisition unit is higher than the temperature threshold Tth and the electrical resistance value is higher than the resistance threshold Rth.

According to the present invention, when the dryness of the electrolyte membrane is determined, two conditions of the electrical resistance value of the fuel cell stack and the temperature of the fuel cell stack are used as the conditions for starting the limiting process of the power generation amount. Thus, the limiting process of the power generation amount is not started more than necessary, which is excellent in terms of user convenience.

(2) In addition, in the fuel cell system, the power generation amount may be limited if the temperature acquired by the temperature acquisition unit remains higher than the temperature threshold for the first predetermined time period ta, and thereafter the electrical resistance value remains higher than the resistance threshold for the second predetermined time period tb. With this configuration, it is possible to prevent power generation amount from being limited by instantaneous noise or the like.

(3) Further, in the fuel cell system, the temperature threshold may be a temperature threshold set in advance based on a processed power generation amount of either an average processing value of power generation amounts within a set time or a low pass filter processing value of power generation amounts, and the temperature threshold may be set to a higher value as the processed power generation amount is larger.

According to this configuration, when the dryness of the electrolyte membrane is determined, the averaging processing or the low pass filter processing is performed. Thus, the power generation amount is not limited due to instantaneous magnitude fluctuation of the power generation amount, which is further excellent in terms of user convenience.

(4) Furthermore, in the fuel cell system, when the temperature decreases to a temperature lower than the temperature threshold Tth during limitation of the power generation amount, the limitation of the power generation amount may be canceled even if the electrical resistance value is higher than the resistance threshold Rth.

As described above, by canceling the limitation of the power generation amount, the amount of water generated by power generation in the fuel cell stack increases and its electrical resistance value decreases. Therefore, the time during which the power generation amount is limited can be shortened, and the dry condition of the electrolyte membrane can be eliminated (the electrolyte membrane can be released from the dry condition) more quickly.

The present invention is not limited to the above-described embodiment, and various configurations could be adopted therein without deviating from the essence and gist of the present invention.

1. A fuel cell system comprising:
a fuel cell stack configured to generate electric power by an electrochemical reaction between a fuel gas and an oxygen-containing gas;
a temperature acquisition unit configured to acquire a temperature of the fuel cell stack;
a resistance acquisition unit configured to acquire an electrical resistance value of the fuel cell stack;
a control device configured to control a power generation amount of the fuel cell stack,
wherein the control device includes one or more processors that execute computer-executable instructions stored in a memory,
the one or more processors execute the computer-executable instructions to cause the fuel cell system to limit a power generation amount if the temperature acquired by the temperature acquisition unit is higher than a temperature threshold and the electrical resistance value is higher than a resistance threshold.

2. The fuel cell system according to claim 1, wherein the power generation amount is limited if the temperature acquired by the temperature acquisition unit remains higher than the temperature threshold for a first predetermined time period, and thereafter the electrical resistance value remains higher than the resistance threshold for a second predetermined time period.

3. The fuel cell system according to claim 1, wherein the temperature threshold is a temperature threshold set in advance based on a processed power generation amount of either an average processing value of power generation amounts within a set time or a low pass filter processing value of power generation amounts, and the temperature threshold is set to a higher value as the processed power generation amount is larger.

4. The fuel cell system according to claim 1, wherein when the temperature decreases to a temperature lower than the temperature threshold during limitation of the power generation amount, the limitation of the power generation amount is canceled even if the electrical resistance value is higher than the resistance threshold.

5. The fuel cell system according to claim 3, wherein when the temperature decreases to a temperature lower than the temperature threshold during limitation of the power generation amount, the limitation of the power generation amount is canceled even if the electrical resistance value is higher than the resistance threshold.

6. The fuel cell system according to claim 4, wherein when the temperature decreases to a temperature lower than the temperature threshold during limitation of the power generation amount, the limitation of the power generation amount is canceled even if the electrical resistance value is higher than the resistance threshold.
